(19) United States
(12) Patent Application Publication
(10) Pub. No.: US 2026/0335691 A1
(43) Pub. Date: Oct. 29, 2026

(54) FIRE EXTINGUISHING, SUPPRESSION AND CONTROL SYSTEMS, NOZZLES, AND NOZZLE ASSEMBLIES THEREFOR, AND METHODS OF DELIVERING FIRE EXTINGUISHING, SUPPRESSION, AND CONTROL AGENTS THEREWITH

(71) Applicant: Janus Fire Systems, Crown Point, IN (US)

(72) Inventors: Daniel Hubert, Lowell, IN (US); Adam James Cody, Cedar Lake, IN (US)

(21) Appl. No.: 19/641,890

(22) Filed: Apr. 8, 2026

Related U.S. Application Data
(60) Provisional application No. 63/796,122, filed on Apr. 28, 2025.

(51) Int. Cl. A62C 31/05; A62C 31/28

(52) U.S. Cl. CPC A62C 31/05; A62C 31/28

(57) ABSTRACT

Fire extinguishing, suppression and control systems, nozzles, nozzle assemblies, and methods for delivering fire extinguishing agents from locations outside the interior of an enclosure and then delivering such agents to the enclosure interior. A fire extinguishing agent is introduced into an interior nozzle body cavity of a nozzle body so that the agent flows though the interior nozzle body cavity in an axial direction thereof. The agent is discharged through orifices located in a wall of the nozzle body so that the agent continues to flow in the axial direction into a tube cavity that extends along an axis that is coaxial with the axial direction of the nozzle body so that the agent continues to flow in the axial direction. The agent exits the tube cavity through an outlet that is coaxial with the axial direction so that the agent exits the tube in the axial direction.

### CROSS-REFERENCE TO RELATED APPLICATIONS

This application claims priority to provisional U.S. Patent Application No. 63/796,122 filed Apr. 28, 2025, the contents of which are incorporated herein by reference.

### BACKGROUND OF THE INVENTION

The present invention generally relates to fire extinguishing, suppression and control systems and their operation. The invention particularly relates to nozzle assemblies, nozzles, and methods capable of use in active fire extinguishing, suppression and control systems that are capable of providing fire protection within an enclosure, for example, an anechoic chamber, with the use of a fire extinguishing agent.

Fire extinguishing, suppression and control systems of types intended to extinguish a fire in a room or other enclosure often utilize a nozzle adapted to distribute and, in some instances vaporize, a fire extinguishing, suppression, or control agent, as nonlimiting examples, halocarbon agents, inert gases, dry chemical powders, and water. The agent is typically delivered to the nozzle through a pipe that may pass through a wall, ceiling, or floor of the room. As a matter of convenience, the term(s) “fire extinguishing system(s)” will be used herein to individually and collectively refer to fire extinguishing systems, fire suppression systems, and fire control systems, and the term(s) “fire extinguishing agent(s)” will be used herein to individually and collectively refer to fire extinguishing agents, fire suppression agents, and fire control agents.

Depending on jurisdiction, fire extinguishing systems are typically required to undergo testing to validate their performance within an enclosure having standardized dimensions. In the United States, such tests are performed by testing laboratories such as UL Solutions (UL) and Factory Mutual Approvals (FM). Depending on the fire extinguishing agent/system and the specific testing protocol, fire protection performance can be based on whether a fire is extinguished, contained, controlled, or some combination thereof. Extinguishment refers to the ability to fully extinguish flaming that does not re-ignite. Containment refers to the ability to confine a fire to one location that burns to exhaustion of available fuel. Control refers to the ability to limit fire growth.

A significant challenge with successfully completing validation test requirements is the ability to extinguish a fire using an absolute minimum quantity of fire extinguishing agent at a minimum system pressure. The minimum pressure requirement challenges the ability of a system to vaporize and distribute the agent. A nozzle design that might achieve acceptable extinguishment results within a room having a maximum standardized room height might not achieve an acceptable performance in a room with a minimum standardized room height and/or maximum standardized coverage area, and a nozzle that performs well under both of these sets of conditions may not perform satisfactorily under other standardized test conditions. Nozzle design processes can often be very empirical in nature in pursuit of obtaining a desirable balance of all variables capable of passing required tests.

Certain fire extinguishing agents (inert gases (e.g., nitrogen or argon) and halocarbons) can be delivered into an enclosure volume through simple nozzle designs to cause a direct reduction of flame temperature and to suppress a fire to the point of extinguishment. However, to achieve these results in a time period required to satisfy UL and FM testing protocols, a fire extinguishing agent delivered into a fire zone at minimum extinguishing concentrations must be applied efficiently to extract as much heat from the fire zone as physically possible to extinguish a fire. For liquid halocarbon clean agents (and water when used in water mist fire extinguishing systems) the smaller the liquid droplets, the greater the agent distribution efficiency, hence a greater contribution to rapid extinguishment. The liquid droplet surface area available for heat transfer increases rapidly as the droplet diameter decreases. In general, and for a given quantity of water, nozzles that produce a spray with large droplets will be less effective in heat extraction than sprays with smaller droplets. Therefore, physical attributes that are benefits of smaller droplet sizes include a reduction in mass and increased surface area per unit mass. The smaller the droplet size, the less their mass, hence the greater the possibility to distribute uniformly, remain airborne and in suspension. The greater the surface area per unit mass, the greater the capability to efficiently absorb heat from a fire.

The simplest and most common means in which to discharge and deliver a fire extinguishing agent into an enclosure is to centrally locate one or more nozzles within the enclosure and disperse the agent outward in a radial pattern. If the volume of the enclosure is generally uniform and there are no external influences such as barriers, obstructions, or forced airflow, the agent will typically be distributed uniformly in a volumetric concentration as designed for fire extinguishment. However, if the intent is to deliver a liquid fire extinguishing agent through a nozzle that requires the use of an extended tube, as in the case when protecting an anechoic chamber lined with a relative thick light-, sound-, or electromagnetic wave absorbing material, the typical approach of locating nozzles in the center of an enclosure and discharging extinguishing agent in a radial pattern may not be acceptable or tolerated. Exposed metallic extinguishing system nozzles and metallic or plastic piping supplying the agent to nozzles located in the enclosure is unacceptable because the hard surfaces of these components may interfere with the functions of the anechoic chamber, for example, by creating an echo or reflection within the interior of the chamber. A tube embedded in and/or passing through an absorbing material and conveying the fire extinguishing agent being discharged from a metallic nozzle is less likely to interfere with the functions of the anechoic chamber. However, confining the agent by the restraints or boundaries of a tube’s walls tends to cause droplets of the agent to coalesce and cause reshaping of the discharge pattern of the agent from an efficient dispersion in a (typically) radial pattern into a predominantly straight and consolidated stream pattern.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, fire extinguishing systems, nozzles, nozzle assemblies, and methods for delivering fire extinguishing agents for total flooding application or local application to an enclosure, including but not limited to an anechoic chamber.

According to a nonlimiting aspect, a nozzle of a nozzle assembly is provided that includes a nozzle body having an interior nozzle body cavity surrounded by a nozzle body wall, a nozzle body opening in communication with the interior nozzle body cavity and adapted for being fluidically coupled to a source of a fire extinguishing agent, and a discharge wall in communication with the interior nozzle body cavity and through which the fire extinguishing agent discharges from the nozzle body. The nozzle further includes a plurality of discharge orifices defined in the discharge wall and adapted for discharging the fire extinguishing agent through the discharge wall.

According to another nonlimiting aspect, a nozzle assembly of a fire extinguishing system is provided that includes a mounting unit, a tube, and a nozzle. The mounting unit includes an inlet body having an interior inlet body cavity surrounded by an inlet body wall, an inlet port in communication with the interior inlet body cavity and adapted for coupling to a source of a fire extinguishing agent, and an inlet body opening in communication with the interior inlet body cavity. The tube has an axis, an interior tube cavity extending along the axis of the tube, and first and second tube ends disposed at axially opposite ends of the tube, the first tube end being received in the interior inlet body cavity through the inlet body opening, an outlet of the tube being located at the second tube end. The nozzle includes a nozzle body having an interior nozzle body cavity surrounded by a nozzle body wall, a nozzle body opening coupled to the inlet port of the inlet body and in communication with the interior nozzle body cavity, a discharge wall in communication with the interior nozzle body cavity and through which the fire extinguishing agent received through the inlet port is discharged from the nozzle body, and a plurality of discharge orifices defined in the discharge wall and adapted for discharging the fire extinguishing agent through the discharge wall.

According to yet another nonlimiting aspect, a fire suppression system is installed in association with an enclosure to deliver a fire extinguishing agent to an interior of the enclosure. The fire extinguishing system includes a nozzle assembly as described above, and the nozzle assembly passes through a structure of the enclosure so that the outlet at the second tube end of the tube is exposed within the interior of the enclosure.

According to still another nonlimiting aspect, a method of delivering a fire extinguishing agent to an interior of an enclosure is provided either by total flooding application or local application. The method includes introducing the fire extinguishing agent into an interior nozzle body cavity of a nozzle body so that the fire extinguishing agent flows though the interior nozzle body cavity in an axial direction of the nozzle body, and discharging all of the fire extinguishing agent through a plurality of discharge orifices in a discharge wall of the nozzle body so that the fire extinguishing agent continues to flow in the axial direction of the nozzle body. The fire extinguishing agent flows through the plurality of discharge orifices into an interior tube cavity that extends along an axis of a tube that is coaxial with the axial direction of the nozzle body so that the fire extinguishing agent continues to flow in the axial direction of the nozzle body. The fire extinguishing agent exits the interior tube cavity through an outlet at a tube end of the tube that is coaxial with the axial direction of the nozzle body so that the fire extinguishing agent exits the tube in the axial direction of the nozzle body, the outlet of the tube being exposed within the interior of the enclosure.

Technical aspects of fire extinguishing systems, nozzles, nozzle assemblies, and methods as described above preferably include the capability of delivering fire extinguishing agents from locations outside the interior of an enclosure and then delivering such agents to the interior of the enclosure, and to do so by total flooding and/or localized application of the fire extinguishing agent to the interior.

These and other aspects, arrangements, features, and/or technical effects will become apparent upon detailed inspection of the figures and the following description.

### BRIEF DESCRIPTION OF THE DRAWINGS

FIGS. 1A, 1B, and 1C schematically represent, respectively, a perspective view, a front view, and a side cross-sectional view of a nonlimiting example of a structure (e.g., wall, floor, or ceiling) of an anechoic chamber, wherein a nozzle assembly passes through the structure and has an outlet at a surface thereof facing an interior of the chamber for the purpose of discharging a fire extinguishing agent into the interior.

FIGS. 2A and 2B schematically represent, respectively, a front view and a side cross-sectional view of another nonlimiting example of a structure of an anechoic chamber, wherein the nozzle assembly of FIGS. 1A-1C is shown passing through the structure at a location different than FIGS. 1A-1C.

FIG. 3 schematically represents a perspective view of the nozzle assemblies of FIGS. 1A-2B.

FIG. 4 schematically represents an exploded perspective view of the nozzle assembly of FIG. 3.

FIG. 5 schematically represents a side view of the nozzle assembly of FIG. 3.

FIG. 6 schematically represents a left end view of the nozzle assembly of FIG. 5.

FIG. 7 schematically represents a cross-sectional view of the nozzle assembly of FIG. 5 taken along section line 7-7.

FIG. 8 schematically represents a cross-sectional view of the nozzle assembly of FIG. 5 taken along section line 8-8.

FIGS. 9A and 9B schematically represent, respectively, perspective and end views of a nozzle of the nozzle assembly of FIG. 3.

FIG. 10 contains a table representing various different combinations of variables that were evaluated during investigations performed to identify suitable configurations for a nozzle of the type represented in FIGS. 9A and 9B.

FIG. 11 contains a table that identifies certain dimensions for nozzles of the type represented in FIGS. 9A and 9B for use in nozzle assemblies of the type represented in FIGS. 3-8.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) to which the drawings relate. The following detailed description also identifies certain but not all alternatives of the embodiment(s) depicted in the drawings. As nonlimiting examples, the invention encompasses additional or alternative embodiments in which one or more features or aspects shown and/or described as part of a particular depicted embodiment could be eliminated, and also encompasses additional or alternative embodiments that combine two or more features or aspects described as part of different embodiments. Therefore, the appended claims, and not the detailed description, are intended to recite what are believed to be some, but not necessarily all aspects of the invention, including certain but not necessarily all of the aspects and alternatives described in the detailed description.

The following describes nozzles 60 and nozzle assemblies 50, as well as fire extinguishing systems and methods utilizing such nozzles 60 and nozzle assemblies 50. As will become evident from the discussion, the nozzles 60 and nozzle assemblies 50 are configured to enable a fire extinguishing agent to be delivered through a structure, such as a wall, ceiling, or floor, of an enclosure, and to deliver the agent as a uniform dispersion of fine droplets that are capable of extinguishing, containing, and/or controlling a fire within an interior of the enclosure that is enclosed by the structure.

Industry practice for nozzles adapted to discharge fire extinguishing agents has been to position one or more simple designed nozzles well within a room, chamber, or other zone to be protected and to configure each nozzle to discharge the agent to create a radial discharge pattern to efficiently distribute the agent within the zone. However, in the case of anechoic chambers whose conditions must be carefully controlled, for example, to absorb light, sound and/or electromagnetic waves by lining the interior surfaces of the anechoic chamber with a light-, sound-, and/or electromagnetic wave absorbing material, placing of one or more nozzles at a position within the interior of the chamber a distance from an interior surface of the chamber can be detrimental to the required properties of the chamber.

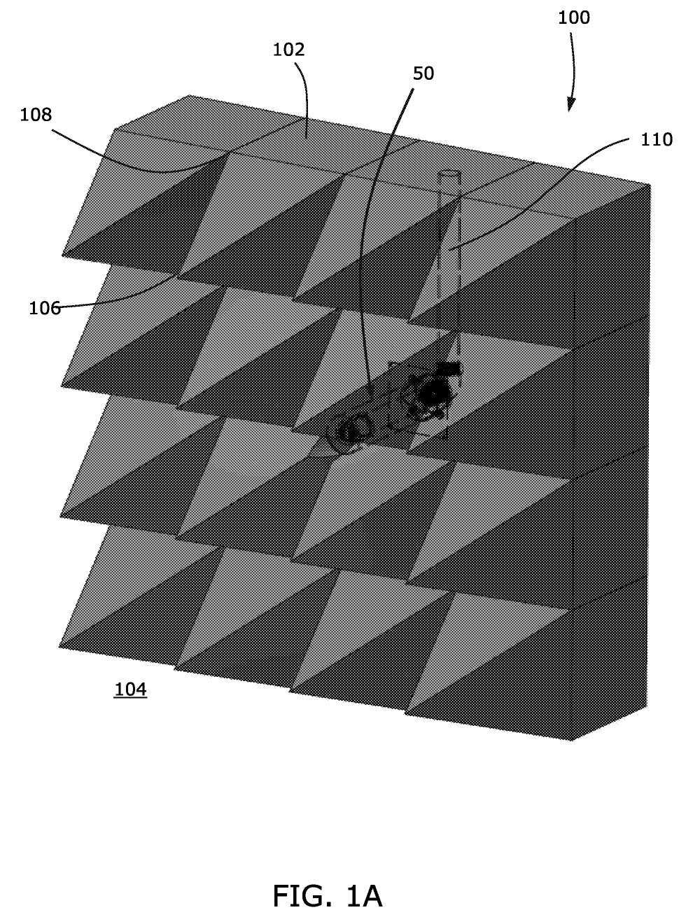

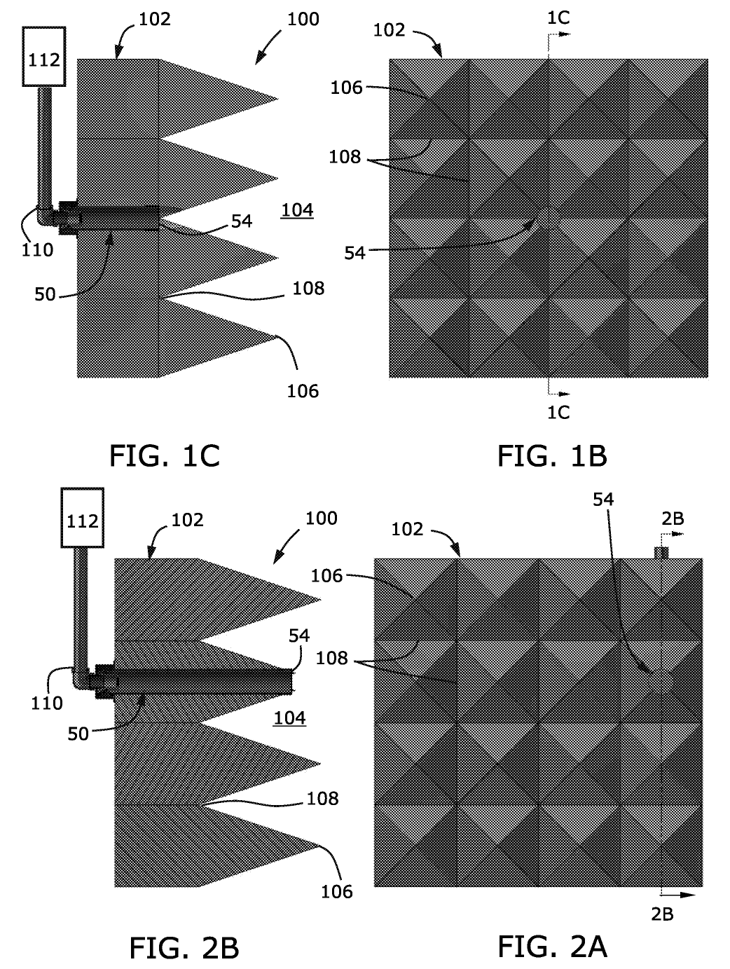

As a solution, the following describes inventions that encompass nozzles 60 and nozzle assemblies 50 that are adapted to discharge a fire extinguishing agent through a tube 52 that extends through a structure 102 of an enclosure, represented as a wall of an anechoic chamber 100 in FIGS. 1A-2B. The tube 52 is represented as terminating at an interior surface of the structure 102 facing into an interior 104 of the chamber 100 so as not to interfere with the desired or required properties of the chamber 100.

With reference to FIGS. 1A-2B, the structure 102 is represented as having an interior surface with peaks 106 and valleys 108 to promote the absorption of energy, for example, light, sound, or electromagnetic waves, within the interior 104 of the chamber 100. In FIGS. 1A, 1B, and 1C, the nozzle assembly 50 is represented as extending through the structure 102 so that an outlet 54 of the tube 52 is exposed at a valley 108 of the interior surface without protruding from the surrounding surface of the valley 108 into the interior 104. In FIGS. 2A and 2B, the nozzle assembly 50 is represented as extending through the structure 102 so that the outlet 54 of the tube 52 is exposed at a peak 106 of the interior surface without protruding from the surrounding surface of the peak 106 into the interior 104. The nozzle assemblies 50 are further represented as being connected to a pipe 110, which in combination with the nozzle assembly 50 are components of a fire extinguishing system that further includes a source 112 of a fire extinguishing agent from (FIG. 1C). The agent may be, as nonlimiting examples, carbon dioxide, a halocarbon agent, inert gas, dry chemical powder, or water mist. Depending on the particular agent used, the source 112 may be pressurized, such as a pressurized tank or a pump. Various aspects of anechoic chambers and fire extinguishing systems are well known to those skilled in the art and therefore will not be described in any detail here.

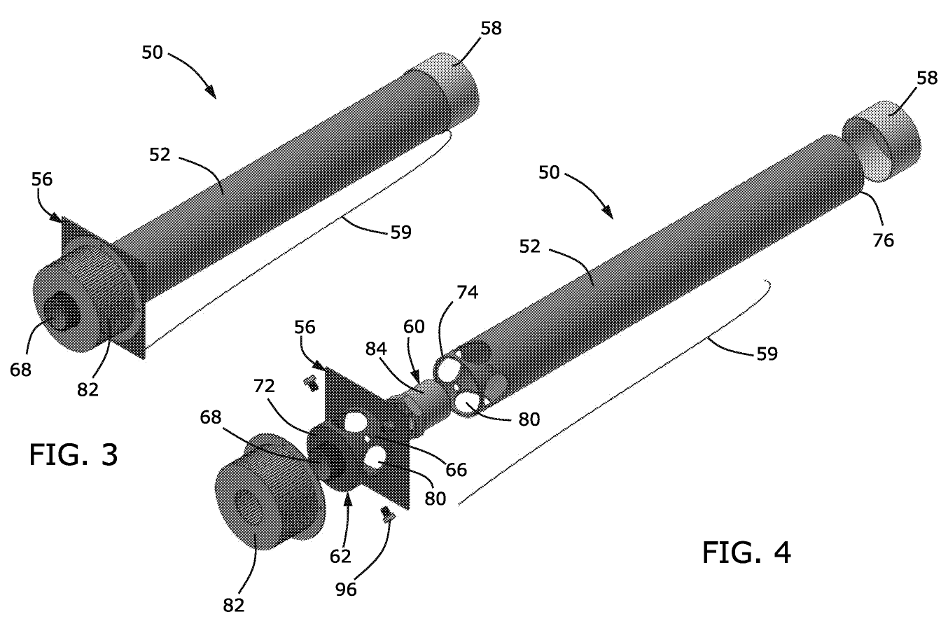

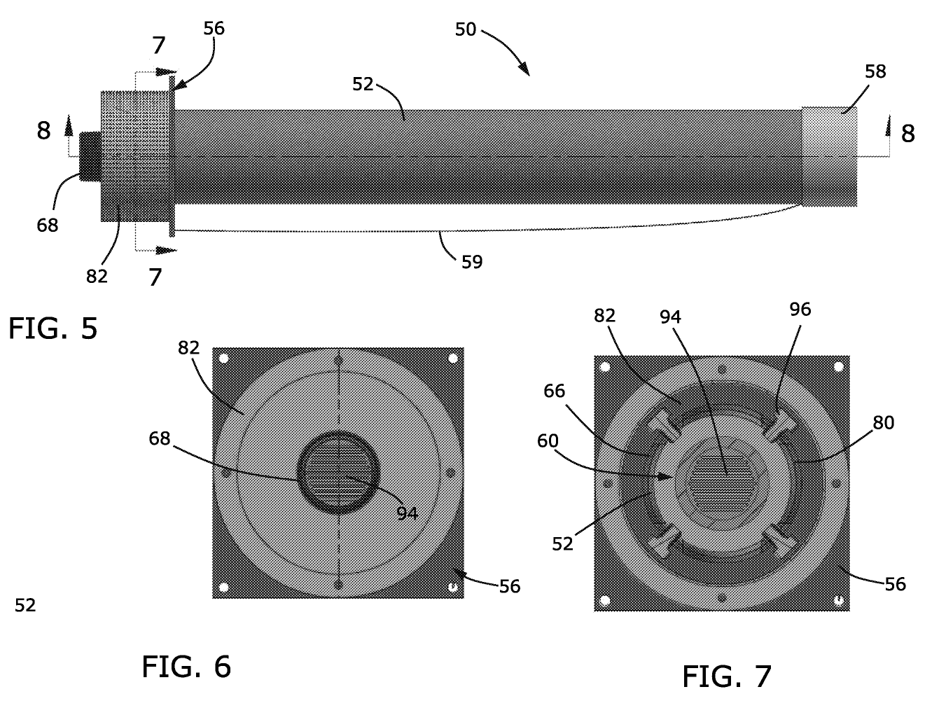

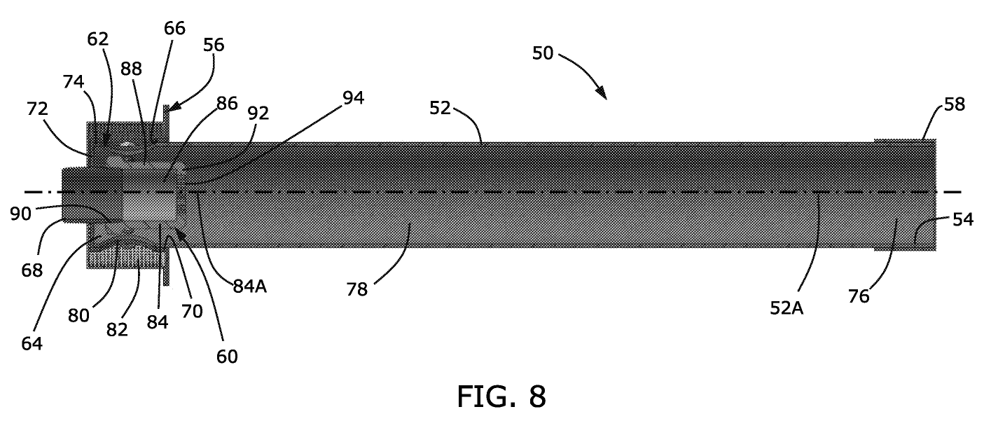

FIGS. 3-10 represent aspects of the nozzle assembly 50 that enable the assembly 50 to be capable of use in a fire extinguishing system for the fire protection of anechoic chambers from fire hazards. The nozzle assembly 50 is configured to be capable of installation in an anechoic chamber 100 with minimal modifications to the chamber 100 and yet also be capable of performing active total flooding or local application of a fire extinguishing agent. With reference to FIGS. 3-8, the nozzle assembly 50 is represented as including the aforementioned tube 52, a mounting unit 56 for securing the nozzle assembly 50 to the structure 102, a cap 58 for closing the outlet 54 of the tube 52, and a nozzle 60 adapted to be located within the tube 52. As more readily seen in FIG. 8, the mounting unit 56 comprises an inlet body 62 having an interior inlet body cavity 64 circumferentially surrounded by an inlet body wall 66, an optional inlet port 68 in communication with the interior inlet body cavity 64 and adapted for coupling to the pipe 110 or another suitable source of the fire extinguishing agent, and an inlet body opening 70 in communication with the interior inlet body cavity 64. The inlet port 68 extends through an axial end wall 72 of the inlet body 62 opposite the inlet body opening 70. The inlet port 68 serves as an adapter for the pipe 110, and therefore may be omitted if unnecessary.

The tube 52 is represented as having a first tube end 74 received within the inlet body cavity 64 through the inlet body opening 70 and secured to the inlet body 62 with screws 96, and a second tube end 76 at which the outlet 54 and cap 58 of the tube 52 are located. The tube 52 can be seen to have a longitudinal axis 52A , such that the first and second tube ends 74 and 76 are disposed at axially opposite ends of the tube 52. The tube 52 defines an interior tube cavity 78 that extends along the axis 52A of the tube 52 throughout the entire length of the tube 52. Generally speaking, the length of the tube 52 can be adapted for the thickness of the structure 102 through which it must pass to deliver the fire extinguishing agent into the interior 104 of the anechoic chamber 100 and any absorptive material lining the structure 102. For use in the anechoic chamber 100, the tube 52 in its entirety or at least its exterior surface is preferably formed of or provided with a light-, sound-, and/or electromagnetic wave absorbing material so as to further reduce the risk of the nozzle assembly 50 having a negative effect on the desired properties of the chamber 100. In investigations leading to the invention, cardboard (i.e., a thin stiff board made from paper pulp) tubing was tested and validated as part of a fire extinguishing system . If suitable or required for operations associated with a specific anechoic chamber/s it is foreseeable that the tube 52 can be constructed of a variety of other materials, including a carbon steel, a stainless steel, brass, copper, aluminum, or a plastic material can be embedded and penetrate through the absorptive to provide similar results as cardboard. If an absorptive material is provided on the exterior surface of the tube 52, it is also foreseeable that the tube 52 can be constructed of a variety of materials, including a carbon steel, a stainless steel, brass, copper, aluminum, or a plastic material.

If utilized, the cap 58 closing the outlet 54 of the tube 52 is preferably a removable cap that is removable by pressure of the fire extinguishing agent flowing through the tube cavity 78, so that the outlet 54 of the tube 52 remains closed until operation of the nozzle assembly 50 commences. As such, the cap 58 or at least its exterior surface is preferably formed of or provided with a light-, sound-, and/or electromagnetic wave absorbing material so as to reduce the risk of the nozzle assembly 50 having a negative effect on the desired properties of the chamber 100. FIGS. 3, 4, and 5 represent the nozzle assembly 50 as further comprising a tether 59 that secures the cap 58 to the nozzle assembly 50 so that the cap 58 can be replaced following the operation of the assembly 50.

The tube 52 and inlet body 62 are represented as having complementary aspiration ports 80 that are adapted to draw air or any other suitable gas into the interior tube cavity 78 as the fire extinguishing agent flows through the tube cavity 78 during use of the nozzle assembly 50, such that air/gas can be entrained in the fire extinguishing agent after it exits from the nozzle 60 and travels through the tube 52. In FIGS. 4, 7, and 8, one set of the aspiration ports 80 is defined in the inlet body wall 66 of the inlet body 62, and a second set of the aspiration ports 80 is disposed in the tube 52 adjacent its first tube end 74. The sets of aspiration ports 80 are radially aligned and in fluidic communication with each other to promote the ingress of air/gas into the tube cavity 78. As will be discussed below, the inclusion of the aspiration ports 80 is particularly desirable when utilizing liquid fire extinguishing agents. For fire extinguishing agents that are discharged through the tube 52 and nozzle 60 as a gas (e.g., nitrogen and/or argon) as opposed to a liquid, the aspiration ports 80 may not be required and in such cases may be omitted.

FIGS. 3-8 further represent the nozzle assembly 50 as comprising a sleeve 82 adapted to cover the inlet body 62 or at least the aspiration ports 80 in its inlet body wall 66 to isolate energy from entering the anechoic chamber 100 or being emitted from the chamber 100 through the nozzle assembly 50 For this purpose, the sleeve 82 can be formed of materials capable of sound wave absorption and/or electromagnetic shielding, while also being gas-permeable so as not to obstruct the aspiration ports 80. For purposes of electromagnetic shielding, the sleeve 82 is preferably constructed of a material that enables the sleeve 82 to function as a Faraday cage to reduce electromagnetic interference that might otherwise be caused by the inlet body 62, in which case the sleeve 82 fully encloses the walls 66 and 72 of the inlet body 62.

The nozzle 60 is represented in FIG. 8 as disposed within and surrounded by the inlet body cavity 64 of the inlet body 62 and within and surrounded by the first tube end 74 of the tube 52. As also seen in FIG. 8, the nozzle 60 is represented as comprising a nozzle body 84 having an interior nozzle body cavity 86 surrounded by a nozzle body wall 88, a nozzle body opening 90 coupled to the inlet port 68 of the inlet body 62 and in communication with the nozzle body cavity 86, a discharge wall 92 in communication with the nozzle body cavity 86 and through which the fire extinguishing agent received through the inlet port 68 is discharged from the nozzle body 84, and a plurality of discharge orifices 94 defined in the discharge wall 92 and adapted for discharging the fire extinguishing agent through the discharge wall 92. The nozzle body 84 can be seen to have a longitudinal axis 84A, such that the nozzle body opening 90 and the discharge wall 92 are disposed at axially opposite ends of the nozzle 60.

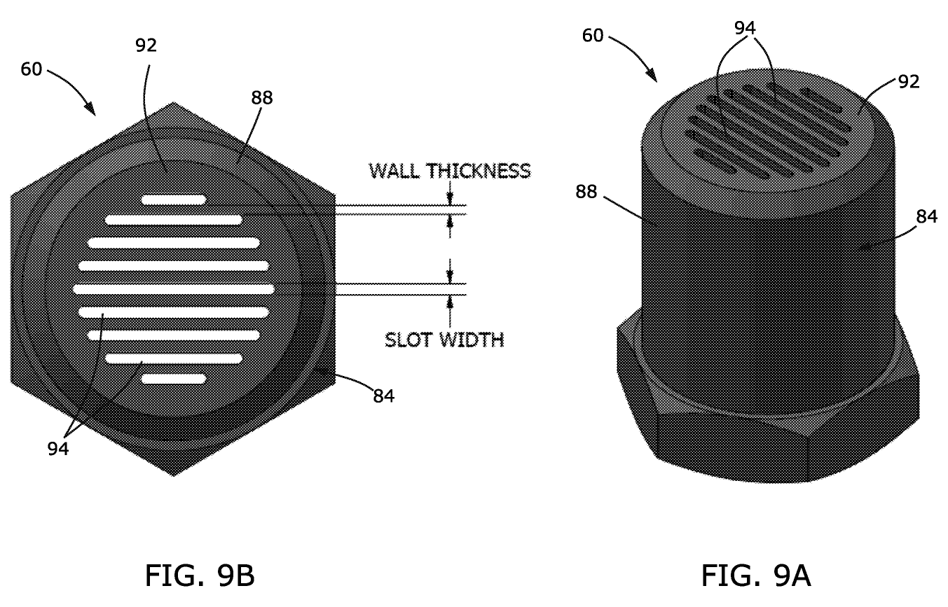

From the configuration of the nozzle assembly 50 shown in the drawings, it can be appreciated that the axis 84A of the nozzle body 84 coincides with the axis (unlabeled) of the inlet body 62, and the axes 52A and 84A of the tube 52 and insert body 84 are preferably coaxial with each other. As such, with the geometric alignment of the inlet body 62, nozzle body 84, and tube 52 and placement of the discharge orifices 94 in the discharge wall 92 at the axial end of the nozzle body 84, the flow of a fire extinguishing agent through the nozzle 60 and then through the tube 52 is entirely in a single axial direction. As more clearly evident from FIGS. 9A and 9B, the nozzle 60 does not have openings in the nozzle body wall 88 that circumferentially surrounds the nozzle body cavity 86. As such, the nozzle 60 is solely adapted to discharge the fire extinguishing agent in an axial direction of the nozzle 60 through the orifices 94 in the discharge wall 92, and not in radial directions of the nozzle 60 through the nozzle body wall 88. To promote a more uniform dispersion of the fire extinguishing agent, the discharge wall 92 is preferably disposed perpendicular to the axis 84A of the nozzle body 84 as represented in the drawings.

The discharge orifices 94 are represented in the drawings as slots that are parallel to each other. However, it is foreseeable that the orifices 94 could have other configurations, such as round (circular) holes or ports. However, as will be discussed below, orifices 94 in the shape of relatively long and narrow slots were shown to exhibit fire extinguishment, suppression, and control capabilities, when using a liquid fire extinguishing agent, which met UL and FM test protocols, whereas circular orifices that were tested did not. The slot-shaped orifices 94 shown in the drawings were determined to physically disrupt the flow pattern of a fire extinguishing agent (fluids (e.g., gases and liquids) and powdered solids) by dividing, reducing and/or changing the droplet size and droplet shape of the agent as it exited the nozzle 60 in a manner that caused the desired droplet size and shape to be maintained throughout its flow through the tube cavity 78 until exiting the tube 52 through the tube outlet 54.

The capability of maintaining a flow pattern in which desired droplet sizes and shapes of a liquid fire extinguishing agent can be maintained throughout the tube cavity 78 is believed to be promoted through the assistance of an aspiration gas drawn into the tube cavity 78. Though air is freely entrained as a fluid is discharged from a nozzle located in an open space, free entrainment of air (or another gas) into a fluid can be restricted if the fluid is being discharged from a nozzle located inside a closed space, such as the tube cavity 78 or other confined structure, thereby affecting whether the liquid retains a dispersed flow pattern as and after it exits the nozzle. For this reason, the nozzle assembly 50 preferably incorporates the aspiration ports 80 to promote the discharge of a fire extinguishing agent by assisting with drawing an aspiration gas into the tube cavity 78. In the illustrated arrangement, the aspiration ports 80, by entraining air or other inert gas, are also believed to be capable of assisting in the shearing, dividing, reducing, and/or modifying of the sizes and shapes of droplets of the fire extinguishing agent discharged from the orifices 94, which can promote a more efficient vaporization of the agent to promote faster suppression and extinguishment of a fire. As such, use of the nozzle 60 in combination with the tube 52 and inlet body 62 is believed to be preferred, though it is also foreseeable that certain benefits of the nozzle 60 could be realized if the nozzle 60 were used independent of the other components of the nozzle assembly 50.

In view of the above, the nozzle assembly 50 and its components are intended to provide a means of which a relatively thick structure can be penetrated and yet still separate and disperse a fire extinguishing agent within an interior of an enclosure in which the structure forms part of the enclosure. Such structures include building materials such as, but not limited to, interior and exterior walls of building, materials located within such walls, structural framing and support members, flooring and ceilings, earth on which such structures may be supported, and any functional or decorative features on the surfaces of such structures. In the particular example in which the structure 102 is part of an anechoic chamber 100 as represented in FIGS. 1A-2B and the nozzle system 50 is intended to address fire hazards within the interior 104 of the chamber 100, interior surfaces of such a structure 102 are likely to include light-, sound-, and/or electromagnetic wave-absorbing materials, for example, a lining of foam or fiberglass material that defines peaks 106 and valleys 108 as represented in the drawings. The nozzle assembly 50 is configured to be able to penetrate structures formed of such materials without interfering with the function of the anechoic chamber 100 and its absorption materials that might create an echo or reflection inside the chamber 100.

During investigations leading to the present invention, various different experimental prototypes of nozzle assemblies were evaluated for their ability to discharge a fire extinguishing agent though a tube capable of being mounted in and penetrating through a wall of an anechoic chamber in a manner that offers fire protection as well as minimizes the reflections/echo disruptions in the chamber. Parameters considered included materials, shapes, and sizes of the orifices 94, diameter and length of the tube 52 relative to the orifices 94, and sizes of the aspiration ports 80. The nozzle 60 and its discharge orifices 94 were of particular interest because their geometries are factors in controlling the discharge pressure, discharge duration, and flow rate of a fire extinguishing agent through the orifices 94, whose geometries also determine the atomization and vaporization of the fire extinguishing agent. Though conventional circular-shaped discharge orifices were evaluated, orifices with other geometric shapes and sizes were also explored.

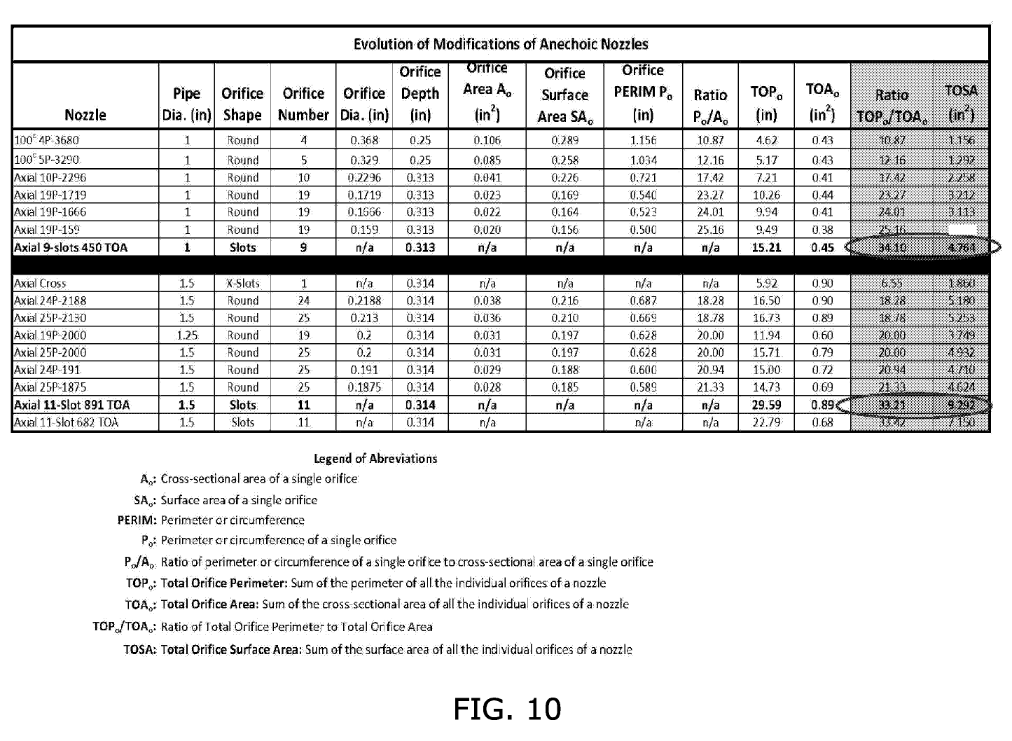

FIG. 10 contains a table representing various different combinations of tube diameters and orifice sizes, geometries, and quantities. For example, tubes were evaluated with diameters (“Pipe Dia.”) of 1, 1.25, and 1.5 inch (about 25, 32, and 38 mm), round, X-shaped, and slot-shaped orifices were evaluated and orifices with diameters of from 0.159 to 0.368 inch (about 4 to 9.35 mm) in various different quantities were evaluated to attain total orifice areas (TOAₒ) ranging from 0.38 to 0.90 square inches (about 245 to about 581 mm²). The values circled in red validate that the slot-shaped orifices were more capable of atomization efficiency than the other tested orifices. On the basis of the investigations, it was concluded that nozzles with orifice shapes and dimensions indicated in FIG. 9B exhibited the capability of providing fire protection within anechoic chambers under both total flooding and localized application of a fire extinguishing agent, and capable of doing so without requiring an existing anechoic chamber to undergo significant modifications.

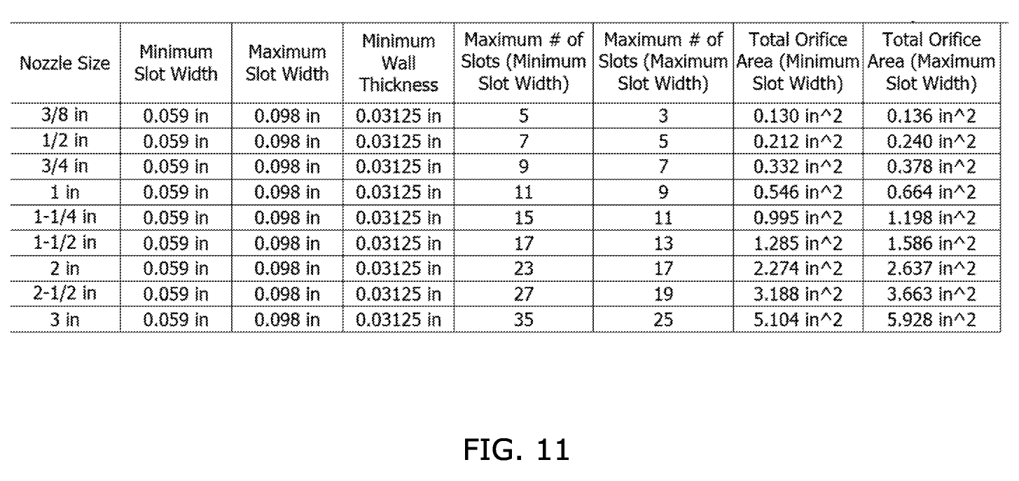

Based on the results of the investigations, FIG. 11 identifies certain combinations of dimensions that were concluded to be suitable for nozzles 60 of the type represented in FIGS. 9A and 9B for use in nozzle assemblies 50 of the type represented in FIGS. 3-8.

As previously noted above, though the foregoing detailed description describes certain aspects of one or more particular embodiments of the invention, alternatives could be adopted by one skilled in the art. As such, and again as was previously noted, it should be understood that the invention is not necessarily limited to any particular embodiment described herein or illustrated in the drawings.

1. A nozzle of a nozzle assembly for a fire suppression system, the nozzle comprising:
a nozzle body having an interior nozzle body cavity surrounded by a nozzle body wall, a nozzle body opening in communication with the interior nozzle body cavity and adapted for being fluidically coupled to a source of a fire extinguishing agent, and a discharge wall in communication with the interior nozzle body cavity and through which the fire extinguishing agent discharges from the nozzle body; and
a plurality of discharge orifices defined in the discharge wall and adapted for discharging the fire extinguishing agent through the discharge wall.

2. The nozzle of claim 1, wherein the nozzle body has an axis and the nozzle body opening and the discharge wall are disposed at axially opposite ends of the nozzle body.

3. The nozzle of claim 2, wherein the nozzle body does not have openings in the nozzle body wall.

4. The nozzle of claim 3, wherein the discharge wall is disposed perpendicular to the axis of the nozzle body.

5. The nozzle of claim 1, wherein the plurality of discharge orifices are slots that are parallel to each other.

6. The nozzle of claim 5, wherein the slots have widths of about 1.6 mm.

7. The nozzle of claim 5, wherein the slots have lengths of about 25 to 40 mm.

8. The nozzle of claim 5, wherein the slots have a total combined area of about 290 to about 575 mm².

9. The nozzle of claim 5, wherein the slots are spaced apart from each other a distance of about 3 mm.

10. A nozzle assembly of a fire suppression system, the nozzle assembly comprising:
a mounting unit comprising an inlet body having an interior inlet body cavity surrounded by an inlet body wall, an inlet port in communication with the interior inlet body cavity and adapted for coupling to a source of a fire extinguishing agent, and an inlet body opening in communication with the interior inlet body cavity;
a tube having an axis, an interior tube cavity extending along the axis of the tube, and first and second tube ends disposed at axially opposite ends of the tube, the first tube end being received in the interior inlet body cavity through the inlet body opening, an outlet of the tube being located at the second tube end; and
a nozzle comprising a nozzle body having an interior nozzle body cavity surrounded by a nozzle body wall, a nozzle body opening coupled to the inlet port of the inlet body and in communication with the interior nozzle body cavity, a discharge wall in communication with the interior nozzle body cavity and through which the fire extinguishing agent received through the inlet port is discharged from the nozzle body, and a plurality of discharge orifices defined in the discharge wall and adapted for discharging the fire extinguishing agent through the discharge wall.

11. The nozzle assembly of claim 10, wherein the nozzle is disposed within the interior inlet body cavity of the inlet body and within the first tube end of the tube.

12. The nozzle assembly of claim 11, further comprising:
at least a first tube aspiration port disposed in the tube adjacent the first tube end; and
at least a first inlet body aspiration port disposed in the inlet body wall of the inlet body;
wherein the first tube aspiration port and the first inlet body aspiration port are aligned and in fluidic communication with each other.

13. The nozzle assembly of claim 12, further comprising a gas-permeable sleeve covering the first tube aspiration port and the first inlet body aspiration port.

14. The nozzle assembly of claim 10, further comprising a removable cap closing the outlet at the second tube end of the tube, the removable cap being removable by pressure of the fire extinguishing agent flowing through the interior nozzle body cavity and the interior tube cavity.

15. The nozzle assembly of claim 14, further comprising a tether that secures the removable cap to the nozzle assembly.

16. The nozzle assembly of claim 10, wherein the tube is formed of a light-, sound-, and/or electromagnetic wave-absorbing material or an exterior surface of the tube is covered with a light-, sound-, and/or electromagnetic wave-absorbing material.

17. The nozzle assembly of claim 10, further comprising a Faraday cage enclosing the inlet body.

18. The nozzle assembly of claim 10, wherein the nozzle body has an axis and the nozzle body opening and the discharge wall are disposed at axially opposite ends of the nozzle body.

19. The nozzle assembly of claim 10, wherein the nozzle body does not have openings in the nozzle body wall.

20. The nozzle assembly of claim 10, wherein the discharge wall is disposed perpendicular to the axis of the nozzle body.

21. The nozzle assembly of claim 10, wherein the plurality of discharge orifices are slots that are parallel to each other.

22. A fire suppression system installed in association with an enclosure to deliver a fire extinguishing agent to an interior of the enclosure, the fire suppression system comprising the nozzle assembly of claim 10, the nozzle assembly passing through a structure of the enclosure so that the outlet at the second tube end of the tube is exposed within the interior of the enclosure.

23. The fire suppression system of claim 22, wherein the enclosure is an anechoic chamber.

24. The fire suppression system of claim 23, wherein the structure of the anechoic chamber has a light-, sound-, and/or electromagnetic wave-absorbing material on surfaces thereof facing the interior of the anechoic chamber.

25. A method of delivering a fire extinguishing agent to an interior of an enclosure, the method comprising:
introducing the fire extinguishing agent into an interior nozzle body cavity of a nozzle body so that the fire extinguishing agent flows though the interior nozzle body cavity in an axial direction of the nozzle body;
discharging all of the fire extinguishing agent through a plurality of discharge orifices in a discharge wall of the nozzle body so that the fire extinguishing agent continues to flow in the axial direction of the nozzle body; and
the fire extinguishing agent flowing through the plurality of discharge orifices into an interior tube cavity that extends along an axis of a tube that is coaxial with the axial direction of the nozzle body so that the fire extinguishing agent continues to flow in the axial direction of the nozzle body, the fire extinguishing agent exiting the interior tube cavity through an outlet at a tube end of the tube that is coaxial with the axial direction of the nozzle body so that the fire extinguishing agent exits the tube in the axial direction of the nozzle body, the outlet of the tube being exposed within the interior of the enclosure.

26. The method of claim 25, wherein a removable cap closes the outlet of the tube, the method further comprising removing the removable cap by pressure of the fire extinguishing agent flowing through the interior nozzle body cavity and the interior tube cavity.

27. The method of claim 25, the method further comprising aspirating the fire extinguishing agent flowing through the interior tube cavity by drawing air into the interior tube cavity through aspiration ports disposed in the tube.

28. The method of claim 25, wherein the plurality of discharge orifices are slots that are parallel to each other.

29. The method of claim 25, wherein the plurality of discharge orifices sufficiently disrupt the flow of the fire extinguishing agent therethrough so as to divide the flow into droplets that remain airborne and distributed without recombining or coalescing into larger liquid droplets as the fire extinguishing agent exits the tube in the axial direction of the nozzle body.

30. The method of claim 25, wherein the fire extinguishing agent passes through a structure of the enclosure as the fire extinguishing agent flows through the interior tube cavity of the tube.

31. The method of claim 30, wherein the enclosure is an anechoic chamber.

32. The method of claim 31, wherein the structure of the anechoic chamber has a light-, sound-, and/or electromagnetic wave-absorbing material on surfaces thereof facing the interior of the anechoic chamber.
